(19) United States
(12) Patent Application Publication
(10) Pub. No.: US 2008/0180350 A1
(43) Pub. Date: Jul. 31, 2008

(54) BROADBAND ANTENNA

(75) Inventors: Benoit Bonnet, Tours (FR); Francois Dupont, Tours (FR)

Correspondence Address: STMicroelectronics Inc.;c/o WOLF, GREENFIELD & SACKS, P.C., 600 Atlantic Avenue, BOSTON, MA, 02210-2206, US

(73) Assignee: STMicroelectronics S.A., Montrouge (FR)

(21) Appl. No.: 12/021,656

(22) Filed: Jan. 29, 2008

(30) Foreign Application Priority Data
Jan. 31, 2007 (FR) FR 07/52990

(51) Int. Cl. H01Q 1/36

(52) U.S. Cl. 343/895

(57) ABSTRACT

An antenna including a planar conductive track, which follows, from a first end intended to be connected to a radiofrequency transceiver circuit to a second free end, a serpentine-shaped pattern having at least three primary parallel sections of the same length, connected, except for a first one and for a last one, by their respective ends to one of the ends of a preceding section and of a next section by secondary rectilinear sections having the same length, perpendicular to the primary sections.

### BACKGROUND OF THE INVENTION

1. Field of the Invention

The present invention relates to radio-frequency reception antennas and, more specifically, to the forming of a broadband antenna.

2. Discussion of the Related Art

The present invention relates to planar antennas formed by conductive tracks on an insulating support. Such antennas have a length which is a function of the desired resonance frequency (approximately the central frequency of the frequency band to be picked up by the antenna). This wavelength corresponds to one quarter (λ/4) of the wavelength (λ) of the desired resonance frequency.

A problem which is posed is that a λ/4 antenna becomes longer as its operating frequency decreases, often resulting in a bulk incompatible with telecommunication device miniaturization requirements.

### SUMMARY OF THE INVENTION

At least one embodiment of the present invention aims at overcoming all or part of the disadvantages of prior art antennas.

An object more specifically aims at the forming of a low-bulk antenna.

Another object aims at an antenna particularly adapted to the reception of signals in frequency bands of several gigahertzes with, preferentially, a bandwidth of more than one gigahertz.

Another object aims at an omnidirectional antenna.

To achieve all or part of these objects, as well as others, at least one embodiment of the present invention provides an antenna comprising a planar conductive track, said track following, from a first end intended to be connected to a radiofrequency transceiver circuit to a second free end, a serpentine-shaped pattern having at least three primary parallel sections of same length, connected, except for a first one and for a last one, by their respective ends to one of the ends of a preceding section and of a next section by secondary rectilinear sections of same length, perpendicular to the primary sections.

According to an embodiment of the invention, an insulating substrate on which it is formed has no earth plane at least straight below it.

According to an embodiment of the invention, the general direction of the serpentine is parallel to a section of connection to a transceiver circuit.

According to an embodiment of the invention, the antenna comprises six primary sections.

According to an embodiment of the invention, the primary sections are rectilinear.

According to an embodiment of the invention, the developed length of the serpentine approximately corresponds to one quarter of the wavelength of the central bandwidth frequency.

According to an embodiment of the invention, the primary sections have non-rectilinear edges.

According to an embodiment of the invention, the primary sections have elliptic edges.

According to an embodiment of the invention, the bandwidth is greater than 1 GHz.

A telecommunication device is also provided.

The foregoing and other objects, features, and advantages of the present invention will be discussed in detail in the following non-limiting description of specific embodiments in connection with the accompanying drawings.

### BRIEF DESCRIPTION OF THE DRAWINGS

FIG. 1 is a partial representation in the form of blocks of a telecommunication device of the type to which the present invention applies;

FIG. 2 shows an example of a usual line antenna;

FIG. 3 shows an example of a usual folded line antenna;

FIG. 4 is a top view of an antenna according to an embodiment of the present invention;

FIG. 5 is a perspective representation of the antenna of FIG. 4;

FIG. 6 is a top view of an antenna according to another embodiment of the present invention;

FIG. 7 is a perspective representation of the antenna of FIG. 6;

FIG. 8 illustrates the frequency response of antennas according to the embodiments of FIGS. 4 to 7;

FIG. 9 illustrates the frequency response of antennas according to the embodiments of FIGS. 4 to 7; and

FIG. 10 is a top view of an antenna according to another embodiment of the present invention.

### DETAILED DESCRIPTION

The same elements have been designated with the same reference numerals in the different drawings which have been drawn out of scale. For clarity, only those elements useful to the understanding of the present invention have been shown and will be described. In particular, telecommunication circuits capable of using an antenna according to the present invention have not been detailed, the present invention being compatible with any usual radio-frequency transceiver device.

An example of application of the present invention relates to antennas intended for wireless telecommunication systems capable of operating on one or several wide frequency bands. These are, for example, communication systems on short distances (under some hundred meters) with operating frequencies of several gigahertzes (for example, known under standards UWB—ultra wide band, or IEEE 802.15). According to this example, the frequency band between 3.1 and 10.6 GHz is divided in five groups of two or three channels each, each channel having a 528-MHz bandwidth. The present invention for example relates to the first group of three channels ranging from 3.168 GHz (3.1) to 4.752 GHz (4.8) requiring devices capable of operating over the entire band of the groups, of a width greater than 1.5 GHz.

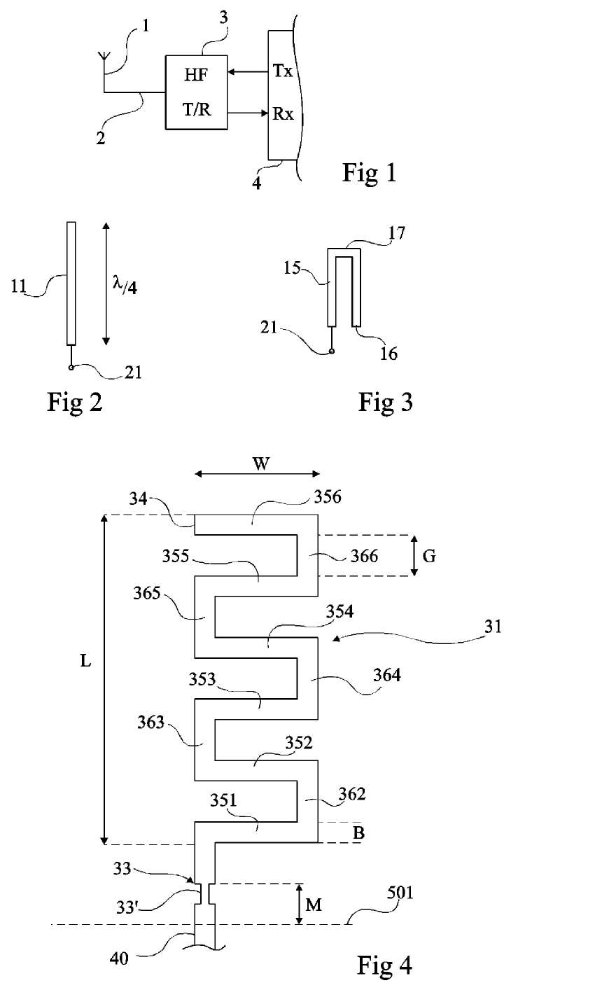

FIG. 1 shows, in the form of blocks, a radio-frequency transceiver circuit of the type to which the present invention applies as an example (for example, a transceiver circuit of a cellular phone for a broadband connection with another transceiver circuit of the same type, for example, of a portable computer).

An antenna 1 is connected by a connection section 2 to a circuit 3 (HF T/R) forming a path separator (between transmission and reception). The two paths of circuit 3 are connected to transmit and receive terminals Tx and Rx of a radio-frequency transceiver circuit 4. The remaining elements of the telecommunication device (for example, those of a portable computer or of a cellular phone) have not been illustrated in FIG. 1.

FIG. 2 shows an example of a conventional line antenna. The antenna comprises a rectilinear conductive track 11 having a length which is a function of the desired resonance frequency (approximately the central frequency of the frequency band to be picked up by the antenna). This length corresponds to one quarter (λ/4) of the wavelength (λ) of the desired resonance frequency. A first end of the track is connected to a terminal 21 of connection to the transceiver device (circuit 3, FIG. 1) and a second end is free.

FIG. 3 shows an example of a usual antenna formed of a folded conductive line, formed of two parallel sections 15 and 16. A first end of section 15 is connected to a first end of section 16 by a perpendicular section 17. The other end of section 15 is connected to a terminal 21 of connection to the transceiver device while the other end of the section 16 is free. The folding aims at decreasing the antenna bulk. However, the coupling between sections necessitates lengthening the developed length of the line with respect to one quarter of the wavelength of the resonance frequency.

FIG. 4 shows, as seen from above, an embodiment of an antenna according to the present invention.

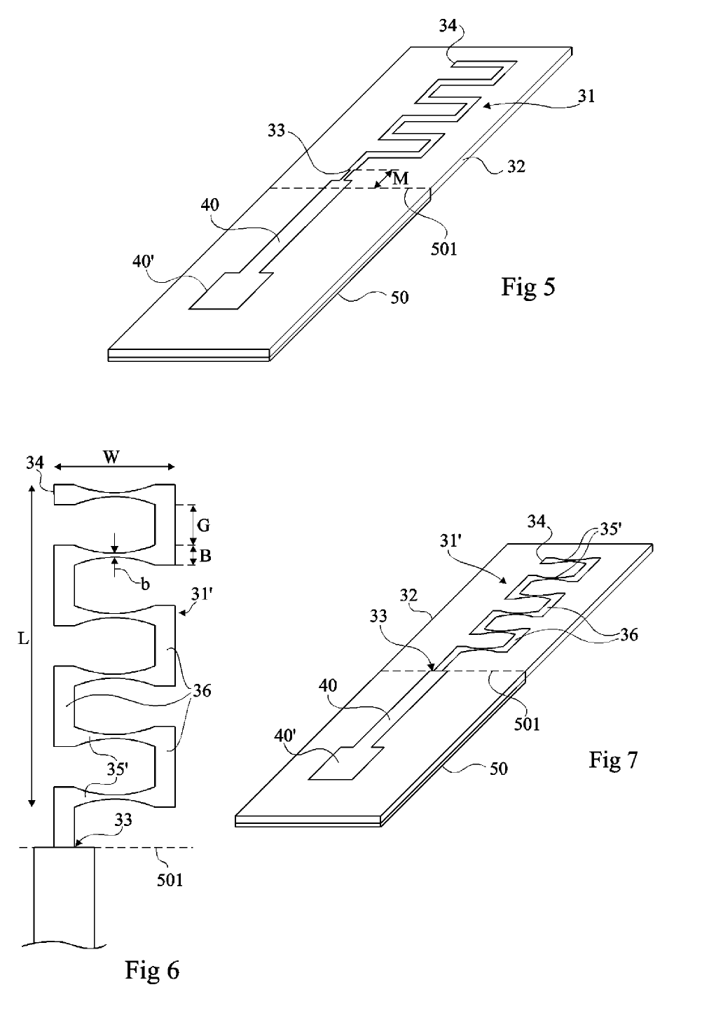

FIG. 5 is a perspective view of such an antenna supported by an insulating substrate.

The antenna comprises a planar conductive track 31 on an insulating substrate 32 (FIG. 5). The track is, for example, obtained by deposition and etching of a metal layer on a first surface (here called the front surface) of substrate 32 (for example, made of silicon, glass, epoxy resin, etc.). A first end 33 of track 31 is connected by a connection section 40 to a pad 40′ of connection to the telecommunication circuit (for example, circuit 3 of FIG. 1). Section 40 and pad 40′ are preferably obtained in the same layer as track 31. Section 40 is sized to exhibit a characteristic impedance (for example, 50 ohms). Further, an earth plane 50 is formed at the rear surface of substrate 32 (or is buried therein) except at least under serpentine 31. In FIGS. 4 and 5, the plumb of the earth plane has been illustrated by a dotted line 501 and this plumb is perpendicular to the general direction of serpentine 31. End 33 of track 31 may be connected to section 40 via a section 33′ narrower than track 31. A second end 34 of track 31 forms the free end of the antenna.

Track 31 follows the pattern of a serpentine with five meanders. From free end 34, the serpentine comprises six primary rectilinear sections 35 (356, 355, 354, 353, 352, and 351) parallel to one another, and five secondary rectilinear sections 36 (366, 365, 364, 363, and 362), also parallel to one another but perpendicular to the primary sections. A last secondary section 361 connects section 40, or a connection 33′, to an end of a first primary section 351 and the other five secondary sections 362 to 366 connect two primary sections 35 together by their respective ends by alternating the ends from one primary section to the other. The path thus successively follows, from end 33 defined as being the end of section 361 on the side of section 40′, sections 361, 351, 362, 352, 363, 353, 364, 354, 365, 355, 366, and 356. Length W of sections 35 is, in this example, greater than length G of sections 36. The opposite is of course possible.

The general direction of serpentine 31 is preferably perpendicular to plumb 501 of the earth plane, and thus parallel to section 40 which is aligned with half of the secondary sections 36. This contributes to the omnidirectional character of the antenna.

An antenna according to the embodiment of FIGS. 4 and 5 comprises several parameters.

One parameter is the number of meanders, which makes the bandwidth wider as the number of meanders decreases. However, the greater the number of meanders, the smaller the bulk.

Another parameter is length W of sections 35 which makes the bandwidth and the resonance frequency all the greater as it is small.

Another parameter is width B of the conductive line forming sections 35 which, makes the bandwidth and the resonance frequency greater as the width increases. Preferably, width B ranges between 0.1 and 1 mm.

Another parameter is gap G between sections 35, which corresponds to the length of sections 36 and which conditions the coupling between meanders. The smaller the gap G, the better the coupling, the less bulky the antenna, but the larger the developed length needs to be for a given resonance frequency.

The above parameters also condition the total developed length of the track (between ends 33 and 34) which, with the length of section 361, conditions the resonance frequency. In the example of FIGS. 4 and 5, this developed length approximately corresponds to one quarter of the wavelength of the resonance frequency which approximately corresponds to the central frequency of the bandwidth.

Another parameter is gap M between serpentine 31 and the plumb of earth plane 50, which corresponds to the length of section 33′ that may be added at one end of section 40. This characteristic is better shown in FIG. 5. The greater this gap, the lower the resonance frequency.

The dimensions of the earth plane provide a second resonance to widen the bandwidth of the antenna. As an example, these dimensions may be on the order of from 16 to 20 mm for the width and on the order of from 22 to 26 mm for the length.

FIGS. 6 and 7 respectively show in top view and in perspective view another embodiment of an antenna according to the present invention.

As compared with the embodiment of FIGS. 4 and 5, sections 35′ have variable widths. In this example, the lateral edges of sections 35′ have curved shapes so that they have a minimum width approximately at mid-length and a maximum width at their ends. The edges of sections 35′ then follow ellipse portions.

This embodiment takes advantage from the fact that high frequencies tend to pass in the middle of the sections whereas low frequencies tend to pass on the edges. Now, since the path on the edges is longer, it corresponds to the quarter of a greater wavelength than that to which the shortest path following the more direct way (middle of the sections) corresponds. Accordingly, this enables decreasing the resonance frequency with respect to an antenna of the embodiment of FIGS. 4 and 5 of same general bulk.

In this embodiment, the wavelength of the resonance frequency approximately corresponds to four times the developed length of the central path (the shortest) and is accordingly shifted towards the low bandwidth frequencies.

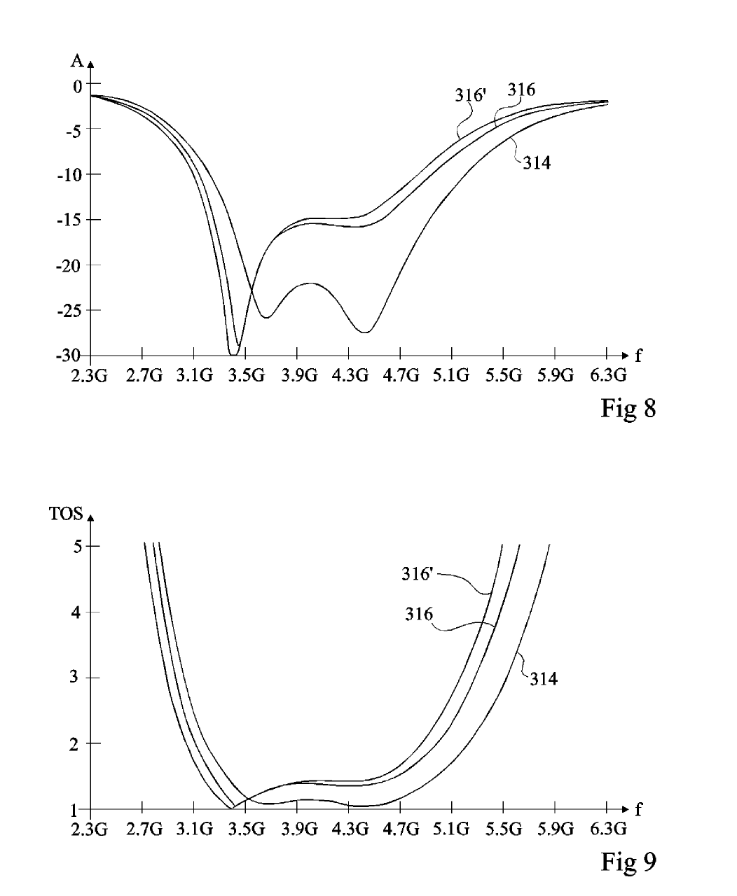

FIGS. 8 and 9 illustrate the frequency responses of antennas such as shown in the above drawings. FIG. 8 shows matching “A” of the antenna (in dB) versus frequency f (in Hz). FIG. 9 shows the voltage standing wave ratio (VSWR) versus frequency f.

On each of FIGS. 8 and 9, the response of an example of an antenna 314 of the type shown in FIGS. 4 and 5 with L=8.1 mm, G=0.9 mm, M=1 mm, B=0.6 mm, and W=2.8 mm, and the responses of examples of antennas 316 and 316′ of the type shown in FIGS. 6 and 7 with L=8.1 mm, G=0.9 mm, M=1 mm, B=0.6 mm, b=0.2 mm, and W=3.2 mm for antenna 316 and W=3.2 mm for antenna 316′ have been illustrated.

There appears from these examples that the embodiment of FIGS. 6 and 7 enables, for the same bulk (antennas 314 and 316), widening the band towards lower frequencies, at the cost, for higher frequencies, of a lesser matching, and of a slightly greater VSWR. For an antenna, a matching is considered as satisfactory from −6 dB and as good under −10 dB, and a VSWR lower than 3 is considered as satisfactory and under 2 as good.

The three examples 314, 316, and 316′ thus are appropriate for the band from 3.1 to 4.8 GHz with, in this band, a better matching and a better VSWR for antennas 316 and 316′.

Antennas 314, 316, and 316′ all have maximum gains greater than 3 dBi (as compared with an isotropic antenna), which is considered as good, a gain greater than 0 dBi being satisfactory.

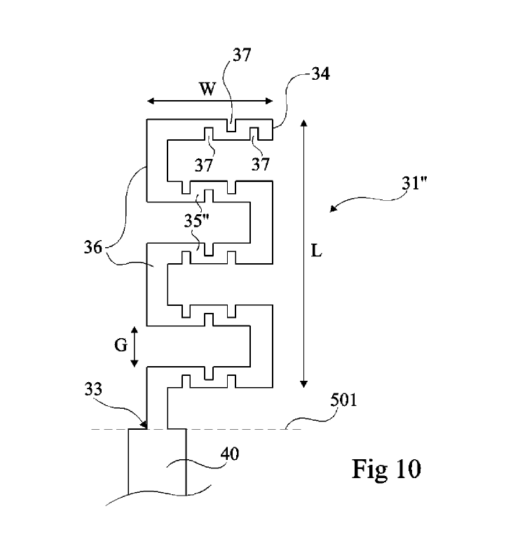

FIG. 10 is a top view of another embodiment of an antenna according to the present invention. According to this embodiment, sections 35″ of serpentine 31″ exhibit perpendicular slots 37 in their longitudinal edges. These slots play a role similar to the edge deformation discussed in relation with FIGS. 6 and 7 to lengthen the path at the periphery.

An advantage of the present invention is that the shape of the provided antenna provides it with a wide band and a low general bulk (surface in which the serpentine inscribes).

An advantage of the present invention is that the obtained antenna altogether exhibits a satisfactory VSWR, attenuation, and gain.

Of course, the present invention is likely to have various alterations, modifications, and improvements which will readily occur to those skilled in the art. In particular, the selection of the different parameters according to the frequencies desired for the operation of the antenna is within the abilities of those skilled in the art based on the functional indications and on the examples given hereabove.

Further, although the present invention has been illustrated by an example of an antenna with six parallel primary sections, the number of meanders may be greater or smaller (at least three).

Further, as an alternative to the shown examples where connection section 40 is parallel to the general serpentine direction, the section may be slanted with respect to this direction (for example up to a few tens of degrees), or even exhibit any slope with respect to the serpentine direction provided to respect the characteristic impedance (for example, 50 ohms).

Further, other passive or active circuits may be supported by substrate 32 provided to respect, around the serpentine, an omnidirectional direction with no earth plane or other conductive element (except for connection section 361) with which an adverse coupling may appear.

Finally, an antenna according to the present invention will find many applications, preferably, in mobile devices (for example, a portable computer, a cell phone, etc.) to communicate with another mobile device or with a fixed equipment (for example, a computer, a transceiver base, etc.), whether this other equipment uses or not an antenna of the same type.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. An antenna comprising a planar conductive track, wherein the track follows, from a first end capable of being connected to a radiofrequency transceiver circuit to a second free end, a serpentine-shaped pattern having at least three primary parallel sections of same length, connected, except for a first one and for a last one, by their respective ends to one of the ends of a preceding section and of a next section by secondary rectilinear sections having a same length, perpendicular to the primary sections, wherein the primary sections have elliptic edges.

2. The antenna of claim 1, wherein an insulating substrate on which it is formed has no earth plane at least straight below it.

3. The antenna of claim 1, wherein the general direction of the serpentine is parallel to a section of connection to a transceiver circuit.

4. The antenna of claim 1, comprising six primary sections.

5. The antenna of claim 1, wherein the bandwidth is greater than 1 GHz.

6. A telecommunication device comprising at least one antenna of claim 1.
